(19) United States
(12) Patent Application Publication
(10) Pub. No.: US 2010/0125524 A1
(43) Pub. Date: May 20, 2010

(54) SECURITY TRANSACTION SYSTEM AND THE METHOD FOR THE SAME

(76) Inventor: Tzu-Ling LIANG, Xizhi City (TW)

Correspondence Address: Muncy, Geissler, Olds & Lowe, PLLC, P.O. BOX 1364, FAIRFAX, VA, 22038-1364, US

(21) Appl. No.: 12/397,122

(22) Filed: Mar. 3, 2009

(30) Foreign Application Priority Data
Nov. 14, 2008 (TW) 097144191

(51) Int. Cl. G06Q 20/00; H04L 9/00

(52) U.S. Cl. 705/75; 705/35; 705/27; 705/39; 705/26

(57) ABSTRACT

The present invention discloses a web transaction system and the method for the same. The web transaction system includes a plurality of merchant severs which deal with customers through a trading platform. Financial providers supply the merchant servers or customers with financial services respectively. A trustee service provider, coupled to the financial providers, provides the merchant servers with entrusting services for reduction in trading risks.

### FIELD OF THE INVENTION

The present invention is generally related to a transaction system. More particularly the present invention is related to the security transaction and the method for the same.

### BACKGROUND OF THE INVENTION

Based on the rapid development of technology, using the transactions or performing shopping in the net has become more frequent. However, conventional e-commerce transaction systems did not provide many consumers sufficient confidence to perform online shopping. Consumers would be concerned about security issues when using their credit cards to perform the shopping. They are worried that if their information of credit cards would be used for illegal matter, the credit card holders would be likely to be responsible for the transactions not being handled or authorized by them.

Modern technology has also made use of the virtual money paid by credit cards or prepaid cards, as an alternative tool of money in web transactions. Some virtual money is used to provide a feedback of interests when the purchase of merchandises through the money is performed. The approach of feedback may include bonus points or the feedback of cash interests, typically having the following limitations: (1) during shopping the bonus points collected can only be used in future shopping before expiration; and (2) during shopping the bonus points collected can be used for the cash discount or cash exchange in future shopping. Thus, the feedback of interests described above is not advantageous for users.

At the present an example of virtual money is widely used in the internet game. A game player before participation has to purchase the virtual money from game providers. From the player's point of view, there is only one-way exchange between real money and virtual money, because generally a game provider does not allow a game player to exchange virtual money into real money. A game player may sell the virtual money collected from the game in a period of time or from other game players to acquire real money. However, if a game is no loner popular or a game provider faces financial predicament, then such virtual money may normally be suffered by devaluation, or even become obsolete. Additionally, the circulation of virtual money may be restricted, because it is not acceptable for each game in between.

Another example is for a prepaid card or value-added card. Such card users must pay the real money in advance to card corporations for the corresponding points or values. The points or values would be saved in the cards, and may be reduced by the card holder's purchase of merchandises, or increased by the card holder's purchase of points or values. Likewise such prepaid card or value-added card is only for a one-way exchange, because card issuers usually do not allow users to exchange remaining points or values into real money. Thus for users the web transactions today, are in a weak position, but not based on an equal relationship, to be vulnerable to exploitation.

At the other hand, for merchant providers, the way of today's online shopping is generally dependent on the large-scale portals to act as a marketing platform, with its significant number of visitors to benefit the merchandises or services in sale with good visibility, and increase its sales. Although it is beneficial for increasing the visibility of merchandises or services to be dependent on the approach of large-scale portals, the portals will however charge for their service fee or posting fee, resulting in the increased cost of operation. Another serious disadvantage is that, the transaction fees from merchant providers must firstly be managed by the portals, and later assigned to each merchant provider in networks, thereby resulting in risks. If the portals mentioned above would face operational difficulties or go into bankruptcy, then the transaction fees from merchant providers would be possibly unable to get back.

Therefore, nowadays technology needs a new transaction method or system, which enables both buyers and sellers to be emerged with good protection, preventing from trading risks.

### SUMMARY OF THE INVENTION

As based on the description above, the present invention is for the purpose of providing a security transaction system and the method for the same.

The present invention discloses a security transaction system, which comprise: a merchant provider for dealing with at least one customer; a financial provider, coupled to the merchant provider for supplying financial services; and a trustee service provider, coupled to the merchant provider for providing entrusting services to reduce trading risks.

The present invention also discloses a security transaction system, which comprises: a commerce platform; a plurality of merchant providers, coupled to the commerce platform for dealing with at least one customer through the commerce platform; a financial provider, coupled to the commerce platform for supplying financial services; and a trustee service provider, coupled to the commerce platform for providing entrusting services to reduce trading risks.

The present invention also discloses a security transaction method, which comprises: providing merchandises or services by a merchant provider; creating a trust account in a trustee service provider by a merchant provider; receiving and confirming the transaction information from at least one customer by the merchant provider; receiving the transaction fees from at least one customer by the trustee service provider when the transactions are completed; and assigning the transaction fees by the trustee service provider to the corresponding merchant provider according to the transaction information.

The forgoing transaction fees traded by a plurality of customers would not be performed directly through the commerce platform to individually assign to the merchant provider, but pre-saved in the trust account of a trustee service provider, and then assigned by the trustee service provider to the merchant provider. Thus this would reduce the risks of making cash flow into commerce platform. If the transaction fees from merchant providers would be concentrated on the commerce platform, and later assigned to a plurality of merchant providers, then those may result in the risks of getting no transaction fees for the merchant providers. If the commerce platform would face operational difficulties or go into bankruptcy, then the plurality of merchant providers under the cash flow would be possibly unable to get the transaction fees. Therefore, the system and method of the present invention would be beneficial to prevent a plurality of merchant providers from the risks of resulting from the poor management upon the commerce platform or from malicious behavior.

Further, the fees of merchandises or the service fees of transactions from the merchant providers and buyers would not be submitted directly to the merchant providers, but firstly to the trust account. When both buyers and sellers have completed the transactions, then the trust agency would submit the transaction fees to the merchant providers, thereby ensuring the security of transactions for both parties.

### BRIEF DESCRIPTION OF THE FIGURES

The elements described above and other features and advantages of the invention will be more apparent, by reading the embodiment description taken in conjunction with the accompanying drawings:

FIG. 1 illustrates a block diagram of web transaction system in accordance with a preferred embodiment of the present invention;

FIG. 2 illustrates a block diagram of web transaction system in accordance with another preferred embodiment of the present invention;

FIG. 3 illustrates a block diagram of web transaction method in accordance with a preferred embodiment of the present invention.

### DETAILED DESCRIPTION OF THE INVENTION

The preferred embodiments taken in conjunction with the accompanying drawings of the present invention are described in details as the followings. It is intended to be understood that, the preferred embodiments of the invention are used only for illustration and description, but not used to limit the invention. In addition, besides the preferred embodiments of the invention the invention would be widely used in other embodiments, and it is not limited to any embodiment depending on the following claims to define the scope of the invention.

The present invention discloses a security transaction system and the method thereof, which can be used in the online shopping mode, other shopping or transaction modes, for ensuring the security of transactions for both buyers and sellers, preventing from trading risks. When merchant providers intend to perform selling, they may create a trust account in advance in a trust agency, to provide the entrusting services and performance bond services. The fees of merchandises or the service fees of transactions from the merchant providers and buyers would not be submitted directly to the merchant providers, but firstly to the trust account. When both buyers and sellers have completed the transactions, then the trust agency would submit the transaction fees to the merchant provider, thereby ensuring the security of transactions for both parties.

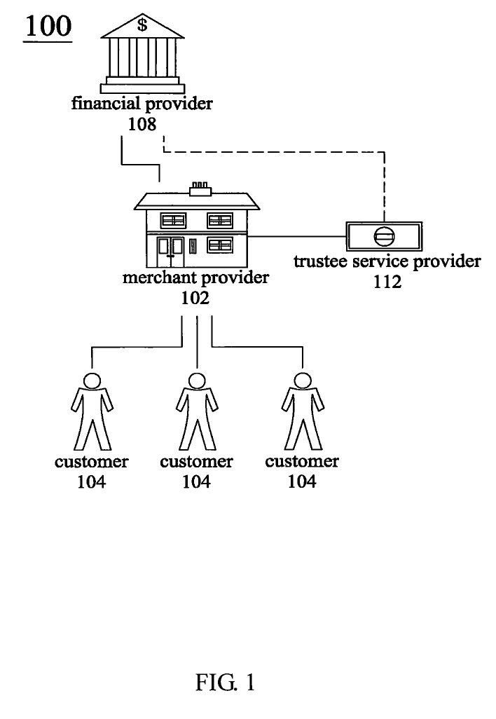

Referring to FIG. 1, a schematic drawing for a security transaction system 100 of the present invention is illustrated. The transaction system 100 includes a merchant provider 102, at least one financial provider 108 and a trustee service provider 112. In the present embodiment, the transaction system 100 communicates through the universal internet as the media between merchant providers and buyers, but not being used for limiting it to the internet form, and any other ways of transactions as suited to the present invention can be used in the invention, for example, such as the transaction way via telecom networks as a substitute for the internet, or the transaction way of the universal store entity.

The dotted line in FIG. 1 represents the relationship of cash flow, and the solid lines represent the relationship of information flow. A plurality of customers 104 and the merchant provider 102 perform transactions. After the transaction information from merchant provider 102 has been confirmed and the chargeback action has been completed by the financial provider 108, the transaction fees would be submitted to a trustee service provider 112. The trustee service provider 112 is introduced between the seller and the buyer to offer entrusting services between thereof to reduce the transaction risk for both parties. When the transactions have been completed, and the customers 104 also get the merchandises or services successfully, then the trustee service provider 112 would withdraw and deposit the transaction fees into the financial provider's account of merchant provider 102.

In this embodiment, merchant provider 102 may have a server, which is a computer host providing associated information of merchant webpages, transmitting html documents to customers via the HTTP protocol. The information of merchant webpages provided by the server of merchant provider 102 is exhibited on the internet, for the browsing or inquiry by non-particular customers 104.

Generally the customers 104 are the potential customers for the merchant provider 102, making use of the computer or terminal with networking function, such as a PDA, mobile phone, laptop or similar devices, to search for the intended merchandises or services through the internet.

The financial provider 108 is to verify the transaction process information and credit information of the customers 104, and inform associated financial provider agencies to perform chargeback action. In a preferred embodiment, the financial provider 108 includes a financial provider and a telecom provider.

The trustee service provider 112 is the legal entity or agency with similar financial provider related function, being able to provide entrusting services. The trustee service provider 112 may also correspond to the financial provider agency where can provide entrusting services generally. The trustee service provider 112 is coupled to the merchant provider 102, for providing the entrusting services and performance bond services. The transaction fees obtained from the merchant provider 102 and customers 104 would not be imported directly into the account of the merchant provider 102, until the transactions have been completed, and then they would be delivered by the trustee service provider 112 to the account of merchant provider 102.

The non-particular customers 104 search for the intended merchandises or services through the internet. When the customers 104 found the merchandises or services exhibited by the merchant provider 102, and decided to purchase them, then the transaction information would be transmitted to the merchant provider 102. In a preferred embodiment, the transaction information described above include the personal information of customers, financial provider's account information of customers, order information and the information of digital signature, etc. After having received the transaction information transmitted from the customers 104, the server of merchant provider 102 would transmit the transaction information to the financial provider 108, for confirming the transaction information, and transmit the confirmed transaction results to the customers 104.

The transaction information would be transmitted by the merchant provider 102 to the financial provider 108 for confirming this transaction, and then the financial provider 108 would verify the transaction information of customers 104. In case of having successfully confirmed this transaction, then the financial provider 108 would inform the financial provider agency correlated with the customers 104 to perform chargeback action, transferring the transaction fees to the trust account created by the merchant provider 102 at the trustee service provider 112. Finally, if this transaction has been completed successfully, then the trustee service provider 112 will transfer these transaction fees to the account of merchant provider 102.

In a preferred embodiment, the merchant provider 102 can also provide the merchandises as similar as virtual money, prepaid cards or value-added cards. Such virtual money or prepaid cards are used for obtaining the services or merchandises provided by the providers above, and the virtual money may be exchanged with real money depending on exchange rate.

The trustee service provider 112 can provide the credit guarantee of these virtual money, to ensure the value of virtual money. When the customers 104 or merchant provider 102 purchases a certain percentage of virtual money, the trustee service provider 112 can make a guarantee for the real value of money. If the merchant provider 102 who issues these virtual money would go into bankruptcy or behave maliciously, resulting in devaluation of the virtual money or being unable to use, then at the moment the trustee service provider 112 can provide the credit guarantee, such that the customers 104 do not need to take the risks described above.

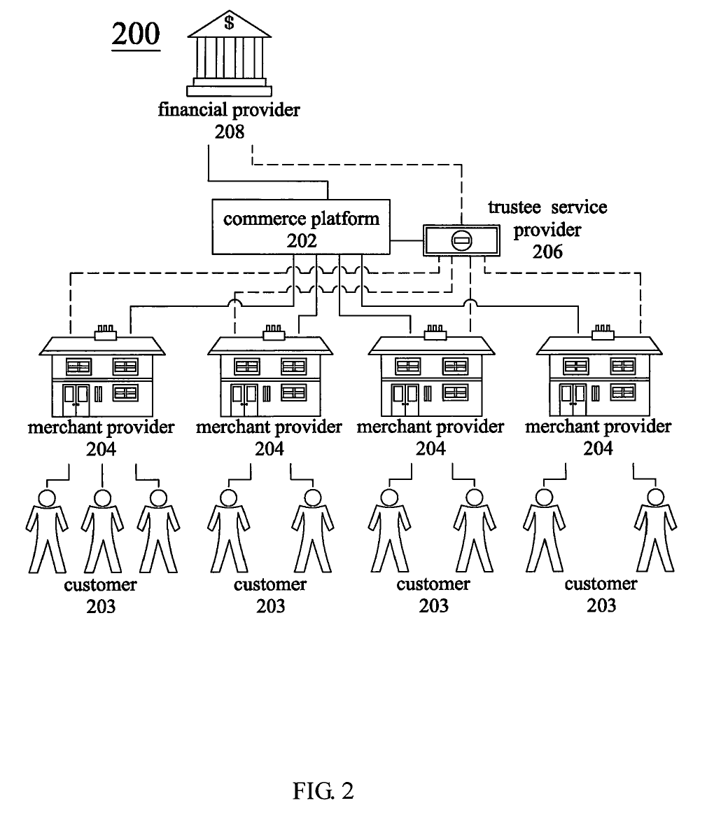

Referring to FIG. 2, according to another embodiment of the present invention, a block diagram of security transaction system 200 is illustrated. A security transaction system 200 includes a commerce platform 202, a trustee service provider 206, a plurality of merchant providers 204 and a financial provider 208. In the present embodiment, the transaction system 200 communicates via the internet or telecom networks as a media between a plurality of merchant providers 204 and customers 203, but not being used for limiting it to the internet, and any ways of transactions as suited to the present invention can be applied in the invention. Since some elements in the transaction system 200 are the same as those in the transaction system 100 in FIG. 1, thus certain duplicated portions will not be described in details, for not being out of focus in the present invention.

The dotted lines represent the relationship of cash flow, and the solid lines represent the relationship of information flow. A plurality of non-particular customers 203 browse the information of merchandises or services exhibited by the merchant providers 204, and perform the transactions with the merchant providers 204. After confirming the transaction information of commerce platform 202 and completing the chargeback action, the financial provider 208 will submit the transaction fees to the trustee service provider 206. When the transactions have been completed, and the customers 203 also get the merchandises or services successfully, the trustee service provider 206 will then withdraw and deposit the transaction fees into the account of the merchant providers 204 in trading.

The information of merchant webpages provided by a plurality of merchant providers 204 is exhibited on the internet via the commerce platform 202, for the browsing or inquiry by non-particular customers, in which commerce platform 202 acts as a communicating media of transactions. In a preferred embodiment, the commerce platform 202 may include a portal (for example, but not limited to, the large traffic websites such as Yahoo, Sina or Google, etc.), an auction website and an online shopping website or a TV shopping channel, leveraging its reputation, to make promotion effect. However, in a preferred embodiment, the merchant providers 204 themselves can also act as a role of the commerce platform 202. Since some merchant providers 204 themselves have been well known, there is no need to depend on the trading platforms with high visibility. The commerce platform 202 in the embodiment of the present invention is thus an optional portion.

The financial provider 208 is to verify the transaction process information and credit information of the customers 203, and inform associated financial provider agencies to perform chargeback action. In a preferred embodiment, the financial provider 208 includes a financial provider and a telecom provider.

The trustee service provider 206 is the legal entity or agency with similar financial provider related function, being able to provide entrusting services. The trustee service provider 206 is coupled to the commerce platform 202, to provide entrusting services and performance bond services for the merchant providers 204. The trustee service provider 206 may also correspond to the financial provider agency where can provide entrusting services. The commerce platform 202 can create a trust account or individually create an independent trust account at the trustee service provider 206. The transaction fees obtained from the merchant providers 204 and customer3, would not be imported directly to directly into the account of the merchant providers 204 or commerce platform 202, until the transactions have been completed, and then they would be transferred by the trustee service provider 206 to the account of merchant providers 204.

The non-particular customers 203 search for the intended merchandises or services through the internet. When a plurality of customers 203 found the merchandises or services exhibited by the merchant providers 204 at the commerce platform 202, and decided to purchase them, then the transaction information would be transmitted to the merchant providers 204 selected. In a preferred embodiment, the transaction information described above include the personal information of customers, financial provider's account information of customers, order information and the information of digital signature, etc. After having received the transaction information transmitted from the customers 203, the merchant providers 204 would transmit the transaction information to the commerce platform 202, and then the transaction information transmitted by the merchant providers 204 will be provided to the financial provider 208, to confirm the transaction information. After the confirmation has been completed, the transaction results will be transmitted by the financial provider 208 to the commerce platform 202, and then the commerce platform 202 will transmit the results to the customers 203; or the commerce platform 202 will transmit the results to the merchant providers 204, and then the results will be transmitted by the merchant providers 204 to the customers 203.

The merchant providers 204 would transmit the transaction information to the corresponding financial provider 208 to confirm, and then the financial provider 208 would transmit the transaction information to the financial provider 208 of customers 203, to confirm the information of transaction process, credit information and account information of the customers 203. In case of having confirmed this transaction, then the financial provider 208 would inform the financial provider agency correlated with the customers 203 to perform chargeback, and will transfer the transaction fees to the trust account created by the merchant providers 204 at the trustee service provider 206. Finally, if this transaction has been completed successfully, then the trustee service provider 206 would transfer this transaction fees to the account of merchant providers 204.

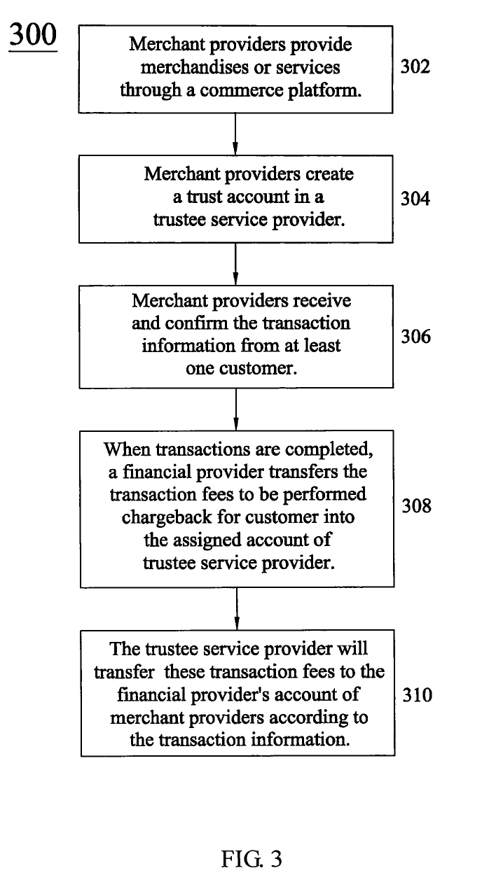

Referring to FIG. 3, according to a preferred embodiment, a security transaction method of the present invention is illustrated. A security transaction method 300 includes: a plurality of merchant providers provide merchandises or services through a commerce platform 302; merchant providers create a trust account in a trustee service provider S304; merchant providers receive and confirm the transaction information from at least one customer S306; when transactions are completed, the trustee service provider receives the transaction fees from the financial provider's account of at least one customer S308; and the trustee service provider assigns the transaction fees to the corresponding merchant providers according to transaction information S310.

Firstly, one or multiple merchant providers may create a trust account in advance in a trustee service provider (S302). The trustee service provider can provide performance bond services and entrusting services for merchant providers, to reduce trading risks.

Merchant information are exhibited by the server of merchant providers via a commerce platform, which acts as the media for communicating with customers, for providing the inquiry or browsing for non-particular customers (S304). This commerce platform may include a portal, an auction website, an online shopping website or a TV shopping channel, leveraging its reputation, to make promotion effect.

The customers connect to commerce platform via the internet to search for the intended merchandises or services. When the customers on the commerce platform found the merchandises or services exhibited by merchant providers, and decided to purchase them, then the transaction information would be transmitted to the merchant providers. After having received the transaction information from customers, the merchant providers would transmit the transaction information to commerce platform, and then the transaction information would be transmitted by the commerce platform to the financial provider, for confirming the transaction information. The commerce platform or merchant providers would transmit the confirmed transaction results to customers (S306). The commerce platform would transmit the transaction information to the financial provider to confirm. In a preferred embodiment, the transaction information described above include the personal information of customers, financial provider's account information of customers, order information and the information of digital signature, etc.

In case of having successfully confirmed this transaction, then the financial provider would inform the financial provider agency correlated with customers to perform chargeback, and transfer the transaction fees to the trust account created by the commerce platform at the trustee service provider (S308).

Finally, if this transaction has been completed successfully, then the trustee service provider will transfer these transaction fees to the financial provider's account of merchant provides according to transaction information (S310).

The forgoing transaction fees traded by a plurality of customers would not be performed directly through the commerce platform, to individually assign to the merchant providers, but pre-saved in the trust account of a trustee service provider, and then assigned by the trustee service provider to the merchant provider. Thus this would reduce the risks of making cash flow into commerce platform. If the transaction fees from merchant providers would be concentrated on the commerce platform in advance, and later assigned to a plurality of merchant providers, then those may result in the risks of getting no transaction fees for the merchant providers. If the commerce platform would face operational difficulties or go into bankruptcy, then the plurality of merchant providers under the cash flow would be possibly unable to get the transaction fees. Therefore, the system and method of the present invention would be beneficial to prevent a plurality of merchant providers from the risks of resulting from the poor management upon the commerce platform or from malicious behavior.

Further, the fees of merchandises or the service fees of transactions from the merchant providers and buyers would not be submitted directly to the merchant providers, but firstly to the trust account. When both buyers and sellers have completed the transactions, then the trust agency would submit the transaction fees to the merchant providers, thereby ensuring the security of transactions for both parties.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A security transaction system, comprising:
a merchant provider, for dealing with at least one customer;
a financial provider, coupled to said merchant provider for supplying financial services; and
a trustee service provider, coupled to said merchant provider for providing entrusting services to reduce trading risks.

2. The system of claim 1, further comprising a commerce platform for providing a media to deal with said merchant provider and said at least one customer, or providing the information of merchandises or services to exhibit for said merchant provider.

3. The system of claim 2, wherein said commerce platform includes a portal, an auction website, an online shopping website or a TV shopping channel.

4. The system of claim 1, wherein said financial provider includes a financial provider or a telecom provider.

5. The system of claim 1, wherein said merchant provider deals with at least one customer through the way of networks or telecommunications.

6. The system of claim 1, wherein said merchant provider creates a trust account at said trustee service provider, and said trustee service provider provides performance bond services for said merchant provider to reduce the trading risks.

7. The system of claim 1, wherein during a transaction process said financial provider transfers the transaction fees to be performed chargeback for said at least one customer into the assigned account of said trustee service provider.

8. The system of claim 1, wherein after said merchant provider has provided the merchandises or services to said at least one customer, then said trustee service provider will provide said merchant provider said transaction fees.

9. The system of claim 1, wherein said at least one customer transmits transaction information to said merchant provider, and after receiving the transaction information of said at least one customer, said merchant provider transmits said transaction information to said financial provider to confirm, in which said transaction information include account information, order information and digital information.

10. The system of claim 1, wherein said merchant provider provides virtual money, prepaid cards or value-added cards, and said trustee service provider provides credit guarantee for said virtual money, said prepaid cards or said value-added cards to guarantee the real value of them.

11. A security transaction method, comprising:
providing merchandises or services by a merchant provider through a commerce platform;
creating a trust account in a trustee service provider by said commerce platform;
receiving and confirming transaction information from at least one customer by said merchant provider;
receiving transaction fees from at least one customer by said trustee service provider when the transactions are completed; and
assigning said transaction fees by said trustee service provider to the corresponding merchant provider according to said transaction information.

12. The system of claim 11, wherein said merchant provider deals with said at least one customer through the way of networks or telecommunications.

13. The system of claim 11, wherein said merchant provider deals with said at least one customer through said commerce platform, or exhibits the information of merchandises or services through said commerce platform.

14. The system of claim 11, wherein said commerce platform includes a portal, an auction website, an online shopping website or a TV shopping channel.

15. The system of claim 11, wherein said financial provider include a financial provider or a telecom provider.

16. The system of claim 11, wherein said trustee service provider provides performance bond services to reduce trading risks.

17. The system of claim 11, wherein during a transaction process said financial provider transfers the transaction fees to be performed chargeback for said at least one customer into the assigned account of said trustee service provider.

18. The system of claim 11, wherein said merchant provider receives the transaction information transmitted from said at least one customer, and after receiving the transaction information of said at least one customer, the plurality of merchant providers transmit said transaction information through said commerce platform to said financial provider to confirm, in which said transaction information include account information, order information and digital signature information.

19. The system of claim 11, wherein said merchant provider provides virtual money, prepaid cards or value-added cards, and said trustee service provider provides credit guarantee for said virtual money, said prepaid cards or said value-added cards to guarantee the real value of them.
